(19) United States
(12) Patent Application Publication
(10) Pub. No.: US 2024/0053998 A1
(43) Pub. Date: Feb. 15, 2024

(54) METHOD AND APPARATUS FOR PROCESSING INTER-CORE COMMUNICATION, AND COMPUTER SYSTEM

(71) Applicant: Black Sesame Technologies (Chongqing) Co., Ltd., Chongqing (CN)

(72) Inventors: BinTong Wen, Chengdu (CN); YouDan Hu, Chengdu (CN); Lin Li, Chengdu (CN)

(21) Appl. No.: 18/233,744

(22) Filed: Aug. 14, 2023

(30) Foreign Application Priority Data
Aug. 12, 2022 (CN) 202210969365.X

(51) Int. Cl. G06F 9/455

(52) U.S. Cl. CPC G06F 9/45533; G06F 2009/45591; G06F 2009/45583

(57) ABSTRACT

The present application proposes a method and an apparatus for processing inter-core communication, and a computer system, and the method includes: acquiring inter-core communication data sent by a target operating system; writing a communication data content in the inter-core communication data into a preset memory, and triggering a target CPU core to read the communication data content from the preset memory; acquiring communication feedback data, where the communication feedback data is feedback data corresponding to the communication data content and sent by the target CPU core; and feeding back the communication feedback data to the target operating system. By adopting the above method for processing inter-core communication, security of a hardware resource in a process of the inter-core communication may be ensured.

### CROSS-REFERENCE TO RELATED APPLICATION

This application claims the benefit under 35 U.S.C. § 119(a) of the filing date of Chinese Patent Application No. 202210969365.X, filed in the Chinese Patent Office on Aug. 12, 2022. The disclosure of the foregoing application is herein incorporated by reference in its entirety.

### TECHNICAL FIELD

The present application relates to the technical field of computer systems, in particular to a method and an apparatus for processing inter-core communication, and a computer system.

### BACKGROUND

In a computer system, communication between a kernel of an operating system and a kernel of a physical server, that is, inter-core communication, is a key to realize data interaction between software and hardware in the computer system.

In a conventional solution of the inter-core communication, an operating system runs directly on a hardware resource of a server, and the operating system may directly perform data communication with a kernel of the server. This inter-core communication mode makes hardware resources of a physical server completely exposed, so that there is a risk of exposing information, and security of the hardware resources cannot be guaranteed.

### SUMMARY

Based on the above technical status, the present application proposes a method and an apparatus for processing inter-core communication, and a computer system, which may improve security of a hardware resource in an inter-core communication process.

A first aspect of the present application provides a method for processing inter-core communication, applied to a virtual machine monitor, and the virtual machine monitor runs between a physical server and an operating system. The method includes: acquiring inter-core communication data sent by a target operating system; writing a communication data content in the inter-core communication data into a preset memory, and triggering a target CPU core to read the communication data content from the preset memory; acquiring communication feedback data, where the communication feedback data is feedback data corresponding to the communication data content and sent by the target CPU core; and feeding back the communication feedback data to the target operating system.

A second aspect of the present application provides a method for processing inter-core communication, applied to a CPU core, and the method includes: reading a communication data content from a preset memory in response to a triggering operation of a virtual machine monitor, where the communication data content is a communication data content written into the preset memory by the virtual machine monitor after inter-core communication data sent by a target operating system is acquired by the virtual machine monitor; generating communication feedback data corresponding to the communication data content; and writing the communication feedback data into the preset memory, and triggering the virtual machine monitor to acquire the communication feedback data, so as to make the virtual machine monitor feed back the communication feedback data to the target operating system.

A third aspect of the present application provides a method for processing inter-core communication, applied to an operating system, and the operating system runs based on a physical server resource allocated by a virtual machine monitor. The method includes: sending inter-core communication data to the virtual machine monitor, so as to make the virtual machine monitor write a communication data content in the inter-core communication data into a preset memory, trigger a target CPU core to read the communication data content from the preset memory, and acquire communication feedback data, where the communication feedback data is feedback data corresponding to the communication data content and sent by the target CPU core; and acquiring the communication feedback data acquired by the virtual machine monitor.

A fourth aspect of the present application provides a computer system, which includes: an operating system, a virtual machine monitor, and a physical server. The virtual machine monitor is configured to run between the operating system and the physical server, and allocate a hardware resource of the physical server to the operating system, and the operating system is configured to run based on a physical server resource allocated by the virtual machine monitor; the operating system is further configured to send inter-core communication data to the virtual machine monitor, and acquire communication feedback data acquired by the virtual machine monitor; the virtual machine monitor is further configured to write a communication data content in inter-core communication data sent by the operating system into a preset memory, trigger a target CPU core in the physical server to read the communication data content from the preset memory, acquire the communication feedback data, and feed back the communication feedback data to the target operating system, where the communication feedback data is feedback data corresponding to the communication data content and sent by the target CPU core; and the target CPU core in the physical server is configured to read the communication data content from the preset memory in response to a triggering operation of the virtual machine monitor, generate the communication feedback data corresponding to the communication data content, write the communication feedback data into the preset memory, and trigger the virtual machine monitor to acquire the communication feedback data.

A fifth aspect of the present application provides an apparatus for processing inter-core communication, applied to a virtual machine monitor, and the virtual machine monitor runs between a physical server and an operating system. The apparatus includes: a first data acquiring unit, configured to acquire inter-core communication data sent by a target operating system; a first data sending unit, configured to write a communication data content in the inter-core communication data into a preset memory and trigger a target CPU core to read the communication data content from the preset memory; a second data acquiring unit, configured to acquire communication feedback data, where the communication feedback data is feedback data corresponding to the communication data content and sent by the target CPU core; and a data feedback unit, configured to feed back the communication feedback data to the target operating system.

A sixth aspect of the present application provides an apparatus for processing inter-core communication, applied to a CPU core, and the apparatus includes: a first data reading unit, configured to read a communication data content from a preset memory in response to a triggering operation of a virtual machine monitor, where the communication data content is a communication data content written into the preset memory by the virtual machine monitor after inter-core communication data sent by a target operating system is acquired by the virtual machine monitor; and a data generating unit, configured to generate communication feedback data corresponding to the communication data content; and a second data sending unit, configured to write the communication feedback data into the preset memory, and trigger the virtual machine monitor to acquire the communication feedback data, so as to make the virtual machine monitor feed back the communication feedback data to the target operating system.

A seventh aspect of the present application provides an apparatus for processing inter-core communication, applied to an operating system, and the operating system runs based on a physical server resource allocated by a virtual machine monitor. The apparatus includes: a third data sending unit, configured to send inter-core communication data to the virtual machine monitor, so as to make the virtual machine monitor write a communication data content in the inter-core communication data into a preset memory, trigger a target CPU core to read the communication data content from the preset memory, and acquire communication feedback data, where the communication feedback data is feedback data corresponding to the communication data content and sent by the target CPU core; and a third data acquiring unit, configured to acquire the communication feedback data acquired by the virtual machine monitor.

According to the method for processing inter-core communication proposed in the present application, a virtual machine monitor is set between an operating system and a physical server, and a communication process between the operating system and a CPU core of the physical server is dominated by the virtual machine monitor. The solution of inter-core communication may realize isolation between the operating system and a hardware layer, the operating system is not capable of acquiring a hardware resource corresponding to the inter-core communication, and thus security of the hardware resource may be ensured.

In addition, an application of the virtual machine monitor may support operation of a plurality of operating systems on a basis of a same set of physical server hardware resources, and each operating system may achieve communication with the peripheral multi-core only by communicating with the virtual machine monitor, so that the inter-core communication between multi-core and multi-operating system may be realized.

### BRIEF DESCRIPTION OF THE DRAWINGS

In order to more clearly illustrate embodiments of the present application or technical solutions in a related art, the accompanying drawings that need to be used in description of the embodiments or the related art are briefly described below. Obviously, the accompanying drawings described below are only embodiments of the present application, for those of ordinary skill in the art, other drawings may be obtained according to the provided drawings without creative efforts.

FIG. 1 is a schematic diagram of a computer system architecture according to an embodiment of the present application.

FIG. 2 is a schematic diagram of a computer system architecture according to another embodiment of the present application.

FIG. 3 is a schematic flowchart of a method for processing inter-core communication according to an embodiment of the present application.

FIG. 4 is a schematic diagram of a process of inter-core communication according to an embodiment of the present application.

FIG. 5 is a schematic diagram of a communication process between an operating system and a virtual machine monitor according to an embodiment of the present application.

FIG. 6 is a schematic flowchart of a method for processing inter-core communication according to another embodiment of the present application.

FIG. 7 is a schematic flowchart of a method for processing inter-core communication according to another embodiment of the present application.

FIG. 8 is a schematic flowchart of a method for processing inter-core communication according to another embodiment of the present application.

FIG. 9 is a schematic structural diagram of an apparatus for processing inter-core communication according to an embodiment of the present application.

FIG. 10 is a schematic structural diagram of an apparatus for processing inter-core communication according to another embodiment of the present application.

FIG. 11 is a schematic structural diagram of an apparatus for processing inter-core communication according to another embodiment of the present application.

### DETAILED DESCRIPTIONS OF THE EMBODIMENTS

Technical solutions in embodiments of the present application are clearly and completely described below with reference to the accompanying drawings in the embodiments of the present application, obviously, the described embodiments are only a part, but not all embodiments of the present application. All other embodiments that may be obtained by those of ordinary skill in the art based on the embodiments in the present application without inventive efforts fall into the protection scope of the present application.

Exemplary Implementation Environment

FIG. 1 shows a schematic diagram of an application scenario applicable to technical solutions of embodiments of the present application. Referring to FIG. 1, the embodiments of the present application are applicable to a hardware implementation environment of an operating system and a physical server, and specifically to a business scenario of communication between a kernel of an operating system and a CPU core of a physical server.

The operating system shown in FIG. 1 may be any operating system running based on a hardware resource of a physical server, for example, a virtual machine operating system, a physical machine operating system, and so on. Moreover, an actual quantity of the operating systems shown in FIG. 1 may be one or more.

The physical server shown in FIG. 1 includes various hardware resources for supporting operation of a system, such as a disk, a memory, where may include one or more CPU cores.

At present, most of conventional inter-core communication based on the application scenario shown in FIG. 1 is communication between multi-core and a single-operating system, that is, there are a plurality of CPU cores in a physical server, an operating system is built based on the physical server, and data communication is performed between a kernel of the operating system and a plurality of CPU cores of the physical server.

However, with progress of times, demand for inter-nuclear communication is also constantly increased, requirements for security of the inter-nuclear communication are getting higher and higher, and communication requirements of multi-core and multi-operating system are also constantly derived.

Traditional inter-core communication is mostly based on a non-virtualized environment, and most operating systems do not isolate software and hardware, and this communication mode has a security risk of exposing information. In addition, a traditional business scenario shown in FIG. 1 is a single operating system running directly on a physical server, which fails to implement a multi-operating system scenario.

Based on a current status and requirements of the above related art, an inventor of the present application proposes a new computer system architecture after research, and proposes a new solution for processing inter-core communication based on the architecture.

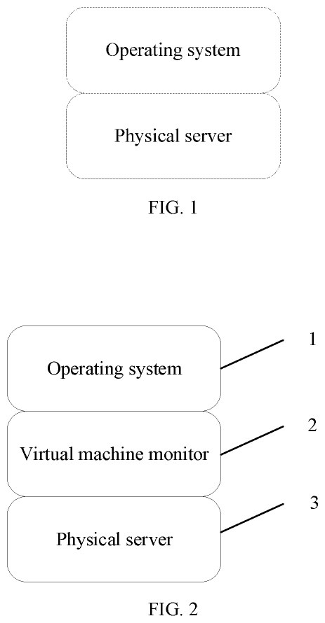

Referring to FIG. 2, an embodiment of the present application proposes a new computer system, which adds a virtual machine monitor (also called Hypervisor) 2 between an operating system 1 and a physical server 3.

A hypervisor is a middle-tier software that runs between a physical server and an operating system, allowing a plurality of operating systems and applications to share a set of basic physical hardware. The hypervisor provides a virtual platform to execute other Guest Operating Systems (GuestOS), and manage an execution phase of other guest operating systems. These guest operating systems, share virtualized hardware resources together. The hypervisor may access all physical devices, including a disk and a memory, on the server, and also need to manage access to memory resources and allocate the memory resources to each virtualized guest operating system, so as to perform protect between virtualized guest operating systems.

Therefore, in a virtualized system, the hypervisor may directly manage physical devices and support running a plurality of GuestOSs on the hypervisor, and the hypervisor provides interface services for each GuestOS, including inter-core communication services.

Based on the above hypervisor settings, the operating system 1 in the computer system shown in FIG. 2 may be one or more, and specifically may be a Host Operating System (HostOS) or a Guest Operating System (GuestOS).

As an optional implementation, a Real-Time Operating System (RTOS) is used as a virtual machine monitor (Hypervisor) in an embodiment of the present application. The Real-Time Operating System (RTOS), also known as an instant operating system, runs and manages system resources in order, and provides a consistent foundation for developing applications.

Compared with a general operating system, the greatest feature of the real-time operating systems is “real-time”, if there is a task that needs to be executed, the real-time operating system will execute the task immediately (in a short time) without a long delay. This characteristic ensures a timely execution of each task. As a more preferred implementation, a RTOS with a microkernel architecture is used as a virtual machine monitor (Hypervisor) in an embodiment of the present application.

Exemplary Methods

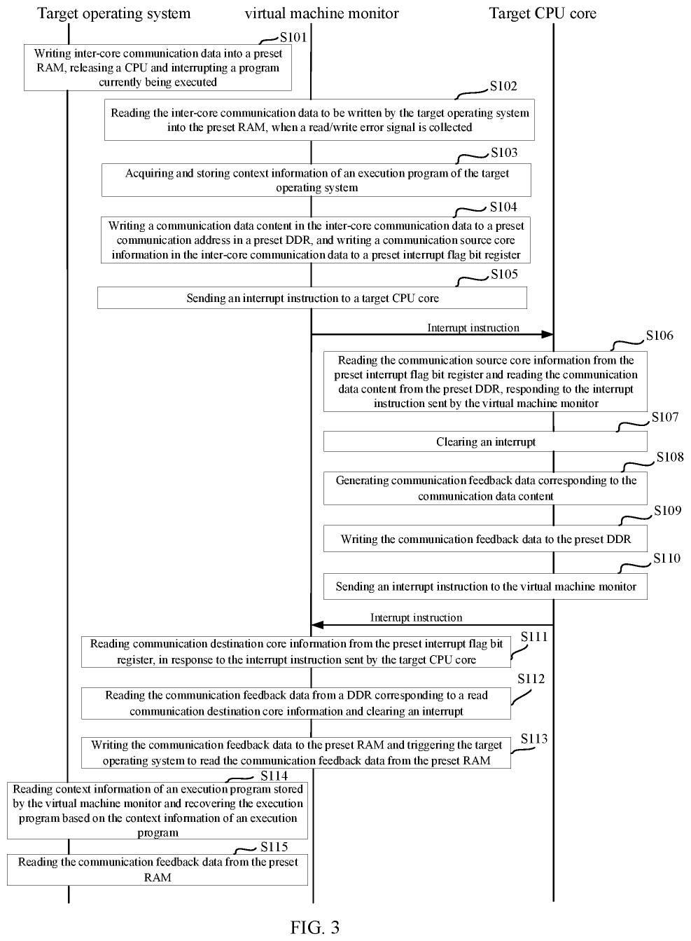

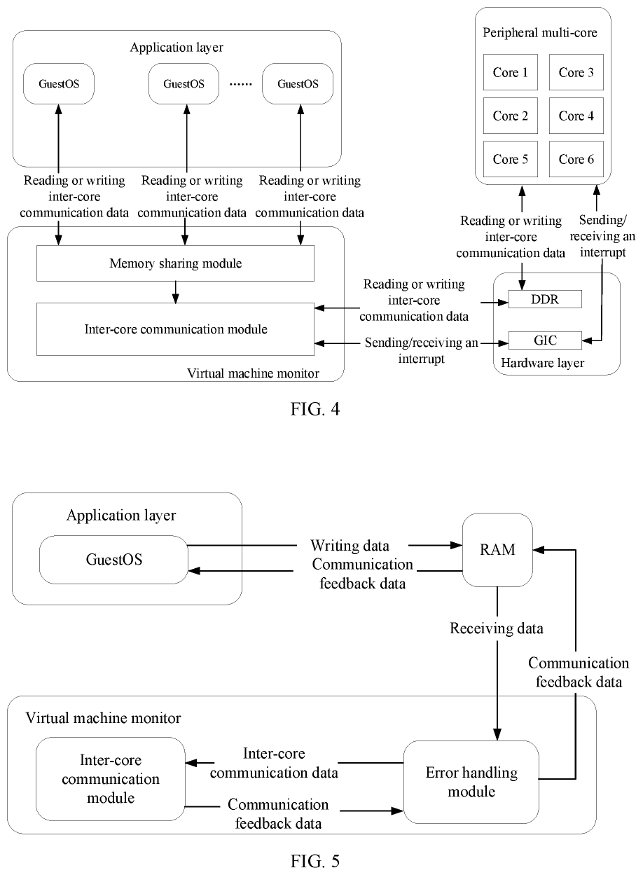

Based on a computer system shown in FIG. 2, an embodiment of the present application proposes a method for processing inter-core communication based on a hypervisor. Based on an architecture of the computer system shown in FIG. 2, the embodiment of the present application is led by the hypervisor to perform a process of the inter-core communication, therefore, the method for processing the inter-core communication proposed in the embodiment of the present application, involves a communication interaction between the operating system, the hypervisor, and a CPU core of the physical server. The following is a detailed introduction to a process of processing the inter-core communication in combination with FIG. 3, FIG. 4, and FIG. 5.

As shown in FIG. 3, an embodiment of the present application proposes a method for processing inter-core communication, which includes the following steps.

S101, writing inter-core communication data into a preset RAM, releasing a CPU and interrupting a program currently being executed by a target operating system.

The above target operating system refers to an operating system running based on a hardware resource allocated by the virtual machine monitor (Hypervisor), which may be a GuestOS running on a virtual platform built by the hypervisor, or a HostOS. In an embodiment of the present application, as shown in FIG. 4, the virtual machine monitor (Hypervisor) builds the virtual platform based on a hardware resource of the physical server, and runs a plurality of GuestOSs on the virtual platform. Each GuestOS is capable of initiating an inter-core communication request, that is, any GuestOS is capable of writing inter-core communication data to the preset RAM. For ease of differentiation, any operating system that conducts inter-core communication is used as the target operating system.

The above preset RAM is a RAM preset by the virtual machine monitor and dedicated to data transfer. The RAM may be shared and used by each GusetOS, but the hypervisor sets a permission that the GusetOS cannot read and write for the RAM, that is, each GuestOS is not capable of actually performing a read/write operation on the RAM, and a read/write operation performed by any GuestOS on the RAM may trigger the RAM to generate a read/write error signal. The read/write error signal is pre-bound to a processing function, which is used to read communication data pre-written into the RAM by the GuestOS.

As shown in FIG. 4, when any operating system GuestOS needs to perform inter-core communication with any CPU core in peripheral multi-core, a communications interface between the GuestOS and the virtual machine monitor (Hypervisor) is first invoked to write inter-core communication data to the foregoing preset RAM, and at the same time, a CPU is released, thereby interrupting a program currently being executed. In this way, the inter-core communication data may be sent to the virtual machine monitor (Hypervisor).

The above inter-core communication data specifically includes a communication source core information, a communication destination core information, and a communication data content.

S102, reading, by a virtual machine monitor, the inter-core communication data to be written by the target operating system into the preset RAM, when the virtual machine monitor collects a read/write error signal.

Specifically, as shown in FIG. 5, when the hypervisor collects a read/write error signal, an error handling module reads communication data pre-written into the RAM by GuestOS by running a processing function bound to the read/write error signal.

Referring to FIGS. 4 and 5, the processing of steps S101 and S102 described above represents a data communication process between the operating system and the virtual machine monitor (Hypervisor), which is mainly implemented in a memory sharing module of the hypervisor.

S103, acquiring and storing context information of an execution program of the target operating system by the virtual machine monitor.

Specifically, as described in step S101, when the target operating system writes the inter-core communication data to the above preset RAM, the CPU may be released and a program currently being executed may be interrupted. Accordingly, the virtual machine monitor (Hypervisor) acquires the context information of the execution program of the target operating system, stores it in a current kernel stack of the target operating system, and retains the kernel stack to the hypervisor.

S104, writing a communication data content in the inter-core communication data to a preset communication address in a preset DDR, and writing a communication source core information in the inter-core communication data to a preset interrupt flag bit register, by the virtual machine monitor.

As shown in FIG. 4, after the memory sharing module of the virtual machine monitor reads the inter-core communication data sent by the target operating system, an inter-core communication module is invoked to perform a communication process with a target CPU core.

As shown in FIG. 4, the inter-core communication module writes the communication data content in the inter-core communication data received by the memory sharing module to the preset communication address in the preset DDR, and writes the communication source core information in the inter-core communication data to the preset interrupt flag bit register.

The preset communication address in the preset DDR described above is a specific communication address in the DDR corresponding to the target CPU core, which is used to store data sent to the target CPU core and store data sent by the target CPU core.

The preset interrupt flag bit register described above is a register set in the virtual machine monitor (Hypervisor) to store core information participating in the inter-core communication.

The inter-core communication module of the hypervisor stores the communication source core information in the inter-core communication data into the preset interrupt flag bit register described above, then determines a target CPU core of this inter-core communication according to the communication destination core information, and then stores the communication data content in the inter-core communication data to the preset communication address in the DDR corresponding to the target CPU core.

S105, sending an interrupt instruction to a target CPU core by the virtual machine monitor.

Specifically, the inter-core communication module of the hypervisor sends an interrupt instruction to a GIC to enable the GIC to transmit the interrupt instruction to the target CPU core. The interrupt instruction is used to trigger the target CPU core to read the communication source core information from the interrupt flag bit register and read the communication data content from the preset DDR.

In the technical solution of the embodiment of the present application, it is preset that when the hypervisor sends an interrupt instruction to the target CPU core, the target CPU core reads the communication source core information from the interrupt flag bit register and reads the inter-core communication data content from the DDR corresponding to the target CPU core. Then, the above operation of sending the interrupt instruction to the target CPU core by the hypervisor may achieve a purpose of triggering the target CPU core to read the communication source core information from the interrupt flag bit register and read the communication data content from the preset DDR.

S106, reading the communication source core information from the preset interrupt flag bit register and reading the communication data content from the preset DDR, by the target CPU core responding to the interrupt instruction sent by the virtual machine monitor.

Specifically, after receiving the interrupt instruction sent by the hypervisor, in response to the interrupt instruction, the target CPU core reads the communication source core information from the preset interrupt flag bit register, and then reads the inter-core communication data content from the above preset DDR corresponding to the target CPU core.

The target CPU core reads the communication source core information to clarify a source of the inter-core communication data content, so as to determine whether and how to respond to the inter-core communication, while the target CPU core reads the communication data content, which may make the target CPU core obtain data sent by the target operating system.

S107, clearing an interrupt by the target CPU core.

Specifically, after the target CPU core reads the communication data content, the interrupt is cleared, and at this time, the hypervisor may detect that the target CPU core clears the interrupt, thereby determining that the target CPU core has received the communication data content of the inter-core communication.

Therefore, the transmission of communication data from the hypervisor to the target CPU core is realized.

S108, generating communication feedback data corresponding to the communication data content by the target CPU core.

S109, writing the communication feedback data to the preset DDR by the target CPU core.

Specifically, after reading the communication data content from the corresponding DDR thereof, in response to the communication data content, the target CPU core generates the communication feedback data corresponding to the communication data content, and then, the target CPU core writes the generated communication feedback data to the preset DDR corresponding to the target CPU core.

S110, sending an interrupt instruction to the virtual machine monitor by the target CPU core.

S111, reading communication destination core information from the preset interrupt flag bit register by the virtual machine monitor, in response to the interrupt instruction sent by the target CPU core.

S112, reading the communication feedback data from a DDR corresponding to a read communication destination core information and clearing an interrupt, by the virtual machine monitor.

Specifically, after writing the communication feedback data to the DDR corresponding the target CPU core, the target CPU core sends the interrupt instruction to the virtual machine monitor.

In the technical solution of the embodiment of the present application, it is preset that when the target CPU core sends the interrupt instruction to the hypervisor, the hypervisor reads the communication destination core information from the interrupt flag bit register, and reads data content from the DDR corresponding to the read target CPU core.

Then, after the hypervisor receives the interrupt instruction sent by the target CPU core, the hypervisor reads the communication destination core information from the interrupt flag bit register, that is, information of the target CPU core may be obtained, and then the hypervisor reads the data content from the DDR corresponding to the target CPU core, that is, the communication feedback data written by the target CPU core may be read.

The above processing mechanism is capable of making the hypervisor to read the corresponding inter-core communication data from the correct DDR in an orderly and accurate manner when multiple GuestOSs perform inter-core communicate with multiple peripheral cores at a same time.

After reading the communication feedback data from the DDR corresponding to the target CPU core, the hypervisor clears the interrupt, and at this time, the sending process of the communication feedback data from the target CPU core to the hypervisor is completed.

S113, writing the communication feedback data to the preset RAM and triggering the target operating system to read the communication feedback data from the preset RAM, by the virtual machine monitor.

S114, reading context information of an execution program stored by the virtual machine monitor and recovering the execution program based on the context information of an execution program, by the target operating system.

Specifically, the target operating system reads, from the kernel stack, the context information of an execution program that is of the target operating system and stored when the hypervisor performs step S103, and recovers the execution program based on the read context information.

S115, reading the communication feedback data from the preset RAM by the target operating system.

Specifically, as shown in FIG. 4 and FIG. 5, after completing communication with the target CPU core, the inter-core communication module of the hypervisor sends an acquired communication feedback data to the memory sharing module, and the memory sharing module still feeds the acquired communication feedback data back to the target operating system in a form of shared memory. Specifically, the memory sharing module writes the acquired communication feedback data to the preset RAM described above, and triggers the target operating system to read data from the RAM.

When the target operating system determines that the hypervisor writes data to the RAM, the data is read from the RAM, which realizes a transmission process of the communication feedback data from the hypervisor to the target operating system.

Therefore, a process of the inter-core communication between the target operating system and the target CPU core is completed.

According to the above introduction, in the method for processing inter-core communication proposed in the embodiment of the present application, a virtual machine monitor is set between the operating system and the physical server, and the communication process between the operating system and a CPU core of the physical server is dominated by the virtual machine monitor. The solution of inter-core communication may realize isolation between the operating system and a hardware layer, the operating system is not capable of acquiring a hardware resource corresponding to the inter-core communication, and thus security of the hardware resource may be ensured.

In addition, an application of the virtual machine monitor may support operation of a plurality of operating systems on a basis of a same set of physical server hardware resources, and each operating system may achieve communication with the peripheral multi-core only by communicating with the virtual machine monitor, so that the inter-core communication between multi-core and multi-operating system may be realized.

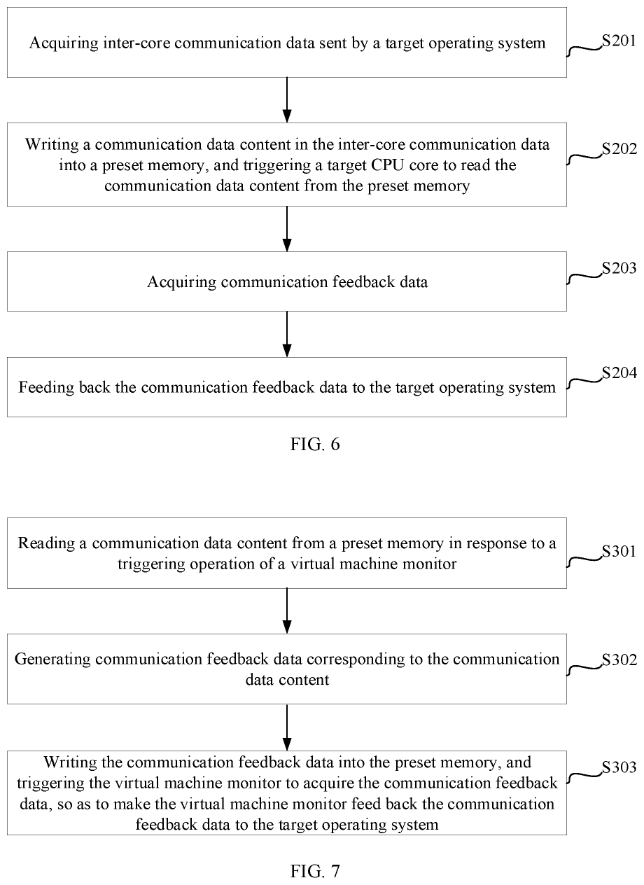

Based on a method for processing inter-core communication shown in FIG. 3, the embodiments of the present application propose a method for processing inter-core communication, which is applied to the virtual machine monitor shown in FIG. 2. Referring to FIG. 6, the method includes:
S201, acquiring inter-core communication data sent by a target operating system;
S202, writing a communication data content in the inter-core communication data into a preset memory, and triggering a target CPU core to read the communication data content from the preset memory;
S203, acquiring communication feedback data, where the communication feedback data is a feedback data corresponding to the communication data content sent by the target CPU core; and
S204, feeding back the communication feedback data to the target operating system.

Meanwhile, the embodiments of the present application also propose a method for processing inter-core communication, which is applied to a CPU core of a physical server shown in FIG. 2. Referring to FIG. 7, the method includes:
S301, reading a communication data content from a preset memory in response to a triggering operation of a virtual machine monitor, where the communication data content is a communication data content written into the preset memory by the virtual machine monitor after inter-core communication data sent by a target operating system is acquired by the virtual machine monitor;
S302, generating communication feedback data corresponding to the communication data content; and
S303, writing the communication feedback data into the preset memory, and triggering the virtual machine monitor to acquire the communication feedback data, so as to make the virtual machine monitor feed back the communication feedback data to the target operating system.

Further, the embodiments of the present application also propose a method for processing inter-core communication, which is applied to an operating system shown in FIG. 2. Referring to FIG. 8, the method includes:
S401, sending inter-core communication data to the virtual machine monitor, so as to make the virtual machine monitor write a communication data content in the inter-core communication data into a preset memory, trigger a target CPU core to read the communication data content from the preset memory, and acquire communication feedback data, where the communication feedback data is feedback data corresponding to the communication data content and sent by the target CPU core; and
S402, acquiring the communication feedback data acquired by the virtual machine monitor.

Specifically, for the specific processing content of each step in the methods, applied to the virtual machine monitor, the CPU core, and the operating system, for processing inter-core communication, reference may be made to the introduction of the corresponding processing steps of a method, shown in FIG. 3, for processing inter-core communication, which is not repeated herein.

Exemplary Apparatus

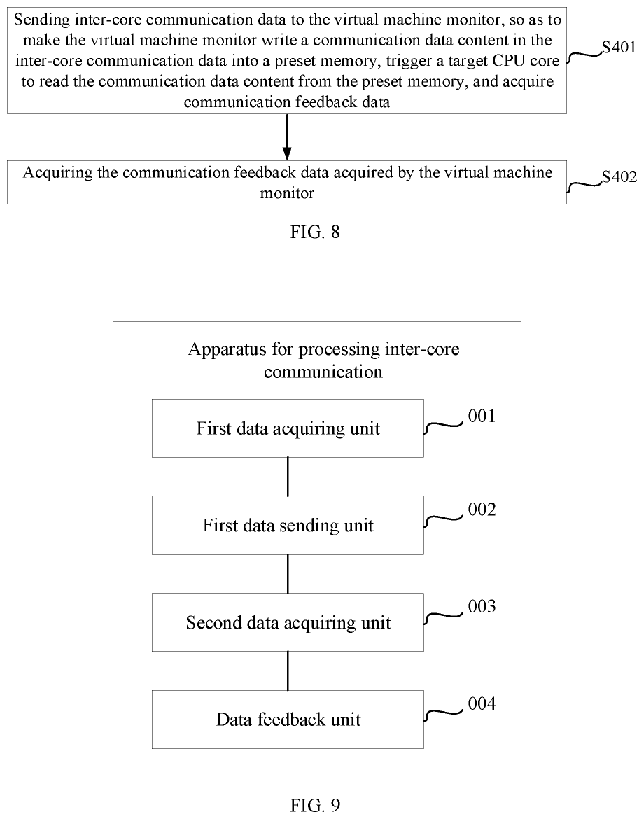

Accordingly, the embodiments of the present application further provide an apparatus for processing inter-core communication, which is applied to a virtual machine monitor, and the virtual machine monitor runs between a physical server and an operating system. Referring to FIG. 9, the apparatus includes:
a first data acquiring unit 001, configured to acquire inter-core communication data sent by a target operating system;
a first data sending unit 002, configured to write a communication data content in the inter-core communication data into a preset memory and trigger a target CPU core to read the communication data content from the preset memory;
a second data acquiring unit 003, configured to acquire communication feedback data, where the communication feedback data is feedback data corresponding to the communication data content and sent by the target CPU core; and
a data feedback unit 004, configured to feed back the communication feedback data to the target operating system.

As an optional implementation, the above acquiring inter-core communication data sent by a target operating system includes:
reading the inter-core communication data to be written into a preset RAM by the target operating system, when a read/write error signal is collected,
where the preset RAM is a RAM that is not readable or writable by the target operating system, and when the inter-core communication data is written into the preset RAM by the target operating system, the preset RAM triggers generation of the read/write error signal.

As an optional implementation, the first data acquiring unit 001 further configured to: when the read/write error signal is collected,
acquire and store context information of an execution program of the target operating system, so as to make the target operating system recover the execution program according to the context information of the execution program.

As an optional implementation, the above feeding back the communication feedback data to the target operating system includes:
writing the communication feedback data into the preset RAM; and
triggering the target operating system to read the communication feedback data from the preset RAM.

As an optional implementation, the inter-core communication data includes communication source core information, communication destination core information, and the communication data content; and
the above writing a communication data content in the inter-core communication data into a preset memory and triggering a target CPU core to read the communication data content from the preset memory includes:
writing the communication data content in the inter-core communication data into a preset communication address in a preset DDR, and writing the communication source core information in the inter-core communication data into a preset interrupt flag bit register, where the preset communication address in the preset DDR is a set communication address in a DDR bound to the target CPU core; and
triggering the target CPU core to read the communication source core information from the interrupt flag bit register and read the communication data content from the preset DDR.

As an optional implementation, the above triggering the target CPU core to read the communication source core information from the interrupt flag bit register and read the communication data content from the preset DDR includes:

sending an interrupt instruction to the target CPU core, so as to make the target CPU core respond to the interrupt instruction, read the communication source core information from the interrupt flag bit register, and read the communication data content from the preset DDR.

As an optional implementation, the above acquiring communication feedback data includes:
reading the communication destination core information from the preset interrupt flag bit register in response to an interrupt instruction sent by the target CPU core; and
reading the communication feedback data from a DDR corresponding to read communication destination core information, and clearing an interrupt, where the communication feedback data in the DDR corresponding to the read communication destination core information is feedback data corresponding to the communication data content in the inter-core communication data, and the feedback data is generated and written by a CPU core corresponding to the read communication destination core information after obtaining the communication data content in the inter-core communication data.

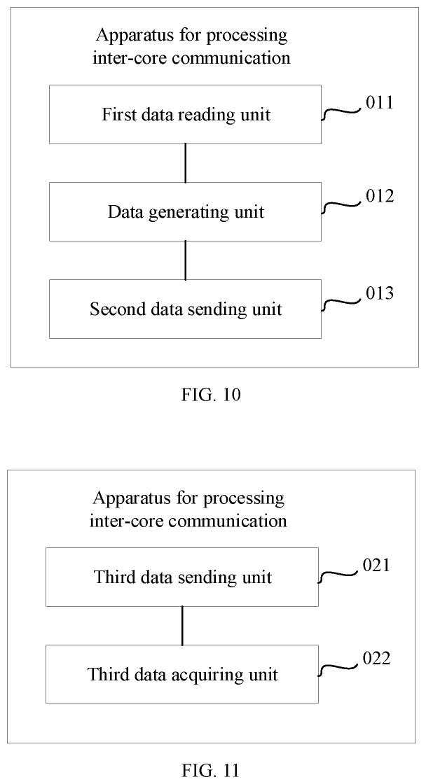

The embodiments of the present application further provide an apparatus for processing inter-core communication, which is applied to a CPU core, and the CPU core is invoked by an operating system managed by a virtual machine monitor, under control of the virtual machine monitor. Referring to FIG. 10, the apparatus includes:
a first data reading unit 011, configured to read a communication data content from a preset memory in response to a triggering operation of a virtual machine monitor, where the communication data content is a communication data content written into the preset memory by the virtual machine monitor after inter-core communication data sent by a target operating system is acquired by the virtual machine monitor;
a data generating unit 012, configured to generate communication feedback data corresponding to the communication data content; and
a second data sending unit 013, configured to write the communication feedback data into the preset memory, and trigger the virtual machine monitor to acquire the communication feedback data, so as to make the virtual machine monitor feed back the communication feedback data to the target operating system.

As an optional implementation, the inter-core communication data includes communication source core information, communication destination core information, and the communication data content; the virtual machine monitor writes the communication data content in the inter-core communication data into a preset communication address in a preset DDR before triggering the CPU core to read the communication data content from the preset memory, and writes the communication source core information and the communication destination core information in the inter-core communication data into a preset interrupt flag bit register; the preset communication address in the preset DDR is a set communication address in a DDR bound to the target CPU core; and
the above reading a communication data content from a preset memory in response to a triggering operation of a virtual machine monitor includes:
reading the communication source core information from the preset interrupt flag bit register and read the communication data content from the preset DDR, in response to an interrupt instruction sent by the virtual machine monitor; and
clearing an interrupt.

As an optional implementation, the above writing the communication feedback data into the preset memory, and triggering the virtual machine monitor to acquire the communication feedback data includes:
writing the communication feedback data into the preset DDR; and
sending an interrupt instruction to the virtual machine monitor, so as to make the virtual machine monitor responds to the interrupt instruction and read the communication feedback data from the preset DDR.

The embodiments of the present application further provide another apparatus for processing inter-core communication, which is applied to an operating system, and the operating system runs based on a physical server resource allocated by a virtual machine monitor. Referring to FIG. 11, the apparatus includes:

a third data sending unit 021, configured to send inter-core communication data to the virtual machine monitor, so as to make the virtual machine monitor write a communication data content in the inter-core communication data into a preset memory, trigger a target CPU core to read the communication data content from the preset memory, and acquire communication feedback data, where the communication feedback data is feedback data corresponding to the communication data content and sent by the target CPU core; and
a third data acquiring unit 022, configured to acquire the communication feedback data acquired by the virtual machine monitor.

As an optional implementation, the above sending inter-core communication data to the virtual machine monitor includes:
writing the inter-core communication data into a preset RAM, release a CPU, and interrupting a program currently being executed; where the preset RAM is a RAM that is not readable or writable by the operating system.

As an optional implementation, after the inter-core communication data is sent to the virtual machine monitor by the operating system, the virtual machine monitor further acquires and stores context information of an execution program of the operating system; and
the third data acquiring unit 022 is further configured to: before the above acquiring the communication feedback data obtained by the virtual machine monitor,
read the context information of the execution program stored in the virtual machine monitor, and recover the execution program based on the context information of the execution program.

As an optional implementation, after acquiring the communication feedback data, the virtual machine monitor writes the communication feedback data into a preset RAM, and the preset RAM is a RAM that is not readable or writable by the operating system; and

The above acquiring the communication feedback data acquired by the virtual machine monitor includes:
reading the communication feedback data from the preset RAM.

Each apparatus for processing inter-core communication provided in the present embodiments belongs to a same application concept as a method for processing inter-core communication provided in the above embodiments of the present application, may execute the method for processing inter-core communication provided by any of the above embodiments of the present application, and has corresponding functional modules and beneficial effects of the execution method. Technical details not described in detail in the present embodiments, may be referred to the specific processing content of the method for processing inter-core communication provided in the above embodiments of the present application, which are not be repeated herein.

Exemplary System

The embodiments of the present application further provide a computer system, referring to FIG. 2, the system includes: an operating system 1, a virtual machine monitor 2, and a physical server 3.

The virtual machine monitor 2 is configured to run between the operating system 1 and the physical server 3, and allocate a hardware resource of the physical server 3 to the operating system 1, and the operating system 1 is configured to run based on a physical server resource allocated by the virtual machine monitor 2;
the operating system 1 is further configured to send inter-core communication data to the virtual machine monitor 2, and acquire communication feedback data acquired by the virtual machine monitor 2;
the virtual machine monitor 2 is further configured to write a communication data content in the inter-core communication data sent by the operating system 1 into a preset memory, trigger a target CPU core in the physical server 3 to read the communication data content from the preset memory, acquire the communication feedback data, and feed back the communication feedback data to the target operating system, where the communication feedback data is feedback data corresponding to the communication data content and sent by the target CPU core; and
the target CPU core in the physical server 3 is configured to read the communication data content from the preset memory in response to a triggering operation of the virtual machine monitor 2, generate the communication feedback data corresponding to the communication data content, write the communication feedback data into the preset memory, and trigger the virtual machine monitor 2 to acquire the communication feedback data.

As an optional implementation, the operating system 1 includes at least one GuestOS, and the virtual machine monitor 2 provides a service interface for each GuestOS, and allocates different physical server hardware resources to each GuestOS; and
the physical server 3 includes a plurality of CPU cores.

Specifically, the hypervisor provides a virtual platform to execute other Guest Operating Systems (GuestOSs), and manage an execution phase of other guest operating systems. These guest operating systems, share virtualized hardware resources together. The hypervisor may access all physical devices, including a disk and a memory, on the server, and also need to manage access to memory resources and allocate the memory resources to each virtualized guest operating system, so as to perform protect between virtualized guest operating systems.

Therefore, in a virtualized system, the hypervisor may directly manage physical devices and support running a plurality of GuestOSs on the hypervisor, and the hypervisor provides interface services for each GuestOS, including inter-core communication services. The GuestOS may be a macro kernel operating system or a microkernel operating system.

As an optional implementation, a Real-Time Operating System (RTOS) is used as a virtual machine monitor (Hypervisor) in an embodiment of the present application. The Real-Time Operating System (RTOS), also known as an instant operating system, runs and manages system resources in order, and provides a consistent foundation for developing applications.

Compared with a general operating system, the greatest feature of the real-time operating systems is “real-time”, if there is a task that needs to be executed, the real-time operating system will execute the task immediately (in a short time) without a long delay. For a critical function of a system, this characteristic ensures a timely execution of a task of inter-core communication. As a more preferred implementation, a RTOS with a microkernel architecture is used as a virtual machine monitor (Hypervisor) in an embodiment of the present application.

According to the embodiment of the present application, the microkernel RTOS is used as a hypervisor, the hypervisor physically separates the GuestOSs into different partitions, and presets a priority of a GuestOS to ensure that the inter-core communication function is at a higher priority on the system. Then, according to the priority setting of GuestOS, the hypervisor manages the inter-core communication required by each GuestOS.

When a plurality of GuestOSs require inter-core communication services, the hypervisor directly takes over the hardware resources required for inter-core communication. The hypervisor allocates a corresponding memory page address space for each GuestOS, and a task thread of a single GuestOS is connected to an address space allocated to the GuestOS and merely accesses and manages the address space. This mechanism ensures isolation between the GuestOSs, and ensures security of a hardware resource of an inter-core communication module. When a single GuestOS application fails, only a memory allocated to this GuestOS is affected, and a memory pool of other GuestOS or hypervisor may not be affected, thus ensuring security and stability of inter-core communication of a single GuestOS in a case of a plurality of GuestOSs.

Based on the above design of system architecture, the inter-core communication process between the operating system and the physical server in the computer system may be referred to the introduction of the embodiments of the method for processing inter-core communication described above, which is not repeated herein.

According to the computer system proposed in an embodiment of the present application, an inter-core communication function is placed in a hypervisor layer. The hardware resources required for the inter-core communication of a plurality of operating systems are unified, so hardware resource optimization can also be achieved in the hypervisor layer, and GuestOS can achieve the inter-core communication only by communicating with the hypervisor layer. Due to the characteristics of the microkernel, the inter-core communication optimization does not need to change an entire operating system, and merely need to replace an old nodule and new module, thus achieving compatibility with a plurality of operating systems.

Moreover, the inter-core communication of the computer system proposed in the embodiment of the present application is completed by the hypervisor layer, and during the entire communication process, the GuestOS is not capable of acquiring a hardware resource corresponding to the inter-core communication, including a physical shared memory and a hardware interrupt.

When the hypervisor layer allocates an address space and a hardware interrupt for the GuestOS, a permission allocating hardware information related to the inter-core communication is not provided to the guest operating system, and the guest operating system is not capable of directly acquiring the resources of the hardware layer, which not only realizes the isolation between the GuestOS and the hardware layer, ensures security of hardware information, improves security of the entire inter-core communication process, but also reduces a dependence of software on a hardware device and a driver.

In addition, in a traditional solution of inter-core communication, when an operating system that requires the inter-core communication is a macro kernel, other kernel drivers of the operating system may directly close an entire system interrupt, and during a communication process, there is a problem that the interrupt closed from time to time or interrupt nesting causes communication asynchronization or interrupt loss. According to the computer system proposed in the embodiments of the present application, a microkernel-based ROST is used as a virtual machine monitor, and the virtual machine monitor performs the process of the inter-core communication. In the microkernel, the processing of a hardware interrupt is controllable and a priority may be adjusted, so that when an inter-core communication is interrupted, even if there are other low-priority interrupt processing programs running, but in a case of allowing interrupt nesting, high-priority interrupt processing may be performed first, and low-priority interrupt processing is performed after the high-priority processing is completed, which improves a real-time performance of the inter-core communication based on the microkernel.

The computer system provided by the present embodiment belongs to a same application concept as a method for processing inter-core communication provided in the above embodiments of the present application, and the computer system may execute the method for processing inter-core communication provided by any of the above embodiments of the present application, and has corresponding functional modules and beneficial effects of the execution method. Technical details not described in detail in the present embodiment, may be referred to the specific processing content of the method for processing inter-core communication provided in the above embodiments of the present application, which are not be repeated herein.

Exemplary Computer Program Product and Storage Medium

In addition to the above methods and devices, an embodiment of the present application may also be a computer program product, which includes computer program instructions, and the computer program instructions, when executed by a processor, cause the processor to perform the steps in a method for processing inter-core communication described in the above “exemplary method” section of present specification.

The computer program product may be a program code, written in any combination of one or more programming languages, for performing operations of the embodiments of the present application, the programming language includes an object-oriented programming language, such as Java, C++, etc., and further includes a conventional procedural programming language, such as “C” language or similar programming language. The program code may be executed entirely on a computing device of a user, executed partially on a user device, executed as a separate software package, partially executed on a computing device of a user and partially executed on a remote computing device, or completely executed on the remote computing device or a server.

Further, an embodiment of the present application may also be a storage medium on which a computer program is stored, and the computer program is executed by a processor to perform the steps in a method for processing inter-core communication described in the above “exemplary method” section of the present specification.

For the embodiments of the foregoing methods, for a sake of brief description, they are expressed as a series of combinations of actions, but those skilled in the art should be aware that the present application is not limited by a sequence of the described actions, because according to the present application, some steps may be performed in other sequences or simultaneously. Secondly, those skilled in the art should also be aware that the embodiments described in the description are preferred embodiments, and the involved actions and modules are not necessarily required for the present application.

It should be noted that various embodiments in the present specification are described in a progressive manner, each embodiment focuses on a difference from other embodiments, and a same or similar part between the various embodiments may be referred to each other. For apparatus class embodiments, because the embodiments are basically similar to the method embodiments, the description is relatively simple, and relevant parts can be referred to a partial description of the method embodiments.

The steps in each method of the embodiments of the present application may be orderly adjusted, merged and deleted according to actual needs, and the technical features described in each embodiment may be replaced or combined.

The modules and sub-modules in each apparatus and terminal of the embodiments of the present application may be merged, divided and deleted according to actual needs.

According to several embodiments provided in the present application, it should be understood that a disclosed terminal, an apparatus and a method may be implemented by other means. For example, the terminal embodiments described above are only schematic, for example, the division of modules or submodules, is only a logical function division, and there may be another division manner in actual implementation, for example, a plurality of submodules or modules may be combined or integrated into another module, or some features may be ignored, or not performed. On another point, the coupling or direct coupling or communication connection between each other shown or discussed may be an indirect coupling or communication connection through some interface, devices or modules, which may be electrical, mechanical or other forms.

A module or submodule described as a separate component may or may not be physically separated, and a component that is a module or submodule may or may not be a physical module or submodule, i.e. may be located in one place, or may also be distributed on a plurality of network modules or submodules. Some or all of the modules or submodules may be selected according to actual needs to achieve the purpose of the present embodiments.

Further, each functional module or submodule in various embodiments of the present application may be integrated in a processing module, or each module or submodule may exist physically alone, or two or more modules or submodules may be integrated in a module. The above integrated modules or submodules may be implemented in a form of hardware or software function modules or submodules.

The professional may further realize that units and algorithm steps of each example described in conjunction with the embodiments disclosed herein may be implemented by electronic hardware, computer software, or a combination of the two. In order to clearly illustrate the interchangeability of hardware and software, the composition and steps of each example have been generally described in accordance with functions in the above description. Whether these functions are performed by hardware or software depends on a specific application and design constraints of the technical solution. Professional technical personnel may use different methods for each particular application to achieve a described function, but such implementation should not be considered beyond a scope of the present application.

The steps of a method or algorithm described in combination with the embodiments disclosed herein, may be directly implemented by a hardware, a software unit executed by a processor, or a combination thereof. The software unit may be placed in a Random Access Memory (RAM), a memory, a Read-Only Memory (ROM), an electrically programmable ROM, an electrically erasable programmable ROM, a register, a hard disk, a removable disks, a CD-ROM, or any other form of storage medium known in the technical field.

Finally, it should also be noted that, herein, relational terms such as first and second, etc., are only used to distinguish an entity or operation from another entity or operation, and do not necessarily require or imply any such actual relationship or order between these entities or operations. Further, the term “comprises”, “includes” or any other variation thereof is intended to cover a non-exclusive inclusion, so that a process, a method, an article or a device including a series of elements includes not only those elements, but also other elements not expressly listed, or elements inherent to such process, method, article or device. In the absence of further restrictions, elements defined by a statement “includes a . . . ” do not exclude the existence of other identical elements in the process, the method, the article or the device including the elements.

The above description of the disclosed embodiments, enables those skilled in the art to implement or use the present application. Various modifications to these embodiments will be obvious to those skilled in the art, and the general principles defined herein may be implemented in other embodiments without departing from the spirit or scope of the present application. Accordingly, the present application will not be limited to these embodiments shown herein, but will conform to the widest range consistent with the principles and novel features disclosed herein.

1. A method for processing inter-core communication, applied to a virtual machine monitor, wherein the virtual machine monitor runs between a physical server and an operating system, and the method comprises:
acquiring inter-core communication data sent by a target operating system;
writing a communication data content in the inter-core communication data into a preset memory, and triggering a target CPU core to read the communication data content from the preset memory;
acquiring communication feedback data, wherein the communication feedback data is feedback data corresponding to the communication data content and sent by the target CPU core; and
feeding back the communication feedback data to the target operating system.

2. The method according to claim 1, wherein the acquiring inter-core communication data sent by a target operating system comprises:
reading the inter-core communication data to be written into a preset RAM by the target operating system, when a read/write error signal is collected,
wherein the preset RAM is a RAM that is not readable or writable by the target operating system, and when the inter-core communication data is written into the preset RAM by the target operating system, the preset RAM triggers generation of the read/write error signal.

3. The method according to claim 2, wherein when the read/write error signal is collected, the method further comprises:
acquiring and storing context information of an execution program of the target operating system, so as to make the target operating system recover the execution program according to the context information of the execution program.

4. The method according to claim 2, wherein the feeding back the communication feedback data to the target operating system comprises:
writing the communication feedback data into the preset RAM; and
triggering the target operating system to read the communication feedback data from the preset RAM.

5. The method according to claim 1, wherein the inter-core communication data comprises communication source core information, communication destination core information, and the communication data content; and
the writing a communication data content in the inter-core communication data into a preset memory, and triggering a target CPU core to read the communication data content from the preset memory comprises:
writing the communication data content in the inter-core communication data into a preset communication address in a preset DDR, and writing the communication source core information in the inter-core communication data into a preset interrupt flag bit register, wherein the preset communication address in the preset DDR is a set communication address in a DDR bound to the target CPU core; and
triggering the target CPU core to read the communication source core information from the interrupt flag bit register and read the communication data content from the preset DDR.

6. The method according to claim 5, wherein the triggering the target CPU core to read the communication source core information from the interrupt flag bit register and read the communication data content from the preset DDR comprises:
sending an interrupt instruction to the target CPU core, so as to make the target CPU core respond to the interrupt instruction, read the communication source core information from the interrupt flag bit register, and read the communication data content from the preset DDR.

7. The method according to claim 5, wherein the acquiring communication feedback data comprises:
reading the communication destination core information from the preset interrupt flag bit register in response to an interrupt instruction sent by the target CPU core; and
reading the communication feedback data from a DDR corresponding to read communication destination core information, and clearing an interrupt, wherein the communication feedback data in the DDR corresponding to the read communication destination core information is feedback data corresponding to the communication data content in the inter-core communication data, and the feedback data is generated and written by a CPU core corresponding to the read communication destination core information after obtaining the communication data content in the inter-core communication data.

8. A method for processing inter-core communication, applied to a CPU core, comprising:
reading a communication data content from a preset memory in response to a triggering operation of a virtual machine monitor, wherein the communication data content is a communication data content written into the preset memory by the virtual machine monitor after inter-core communication data sent by a target operating system is acquired by the virtual machine monitor;
generating communication feedback data corresponding to the communication data content; and
writing the communication feedback data into the preset memory, and triggering the virtual machine monitor to acquire the communication feedback data, so as to make the virtual machine monitor feed back the communication feedback data to the target operating system.

9. The method according to claim 8, wherein the inter-core communication data comprises communication source core information, communication destination core information, and the communication data content; the virtual machine monitor writes the communication data content in the inter-core communication data into a preset communication address in a preset DDR before triggering the CPU core to read the communication data content from the preset memory, and writes the communication source core information in the inter-core communication data into a preset interrupt flag bit register; the preset communication address in the preset DDR is a set communication address in a DDR bound to the target CPU core; and
the reading a communication data content from a preset memory in response to a triggering operation of a virtual machine monitor comprises:
reading the communication source core information from the preset interrupt flag bit register and reading the communication data content from the preset DDR, in response to an interrupt instruction sent by the virtual machine monitor; and
clearing an interrupt.

10. The method according to claim 9, wherein writing the communication feedback data into the preset memory, and triggering the virtual machine monitor to acquire the communication feedback data comprises:
writing the communication feedback data into the preset DDR; and
sending a second interrupt instruction to the virtual machine monitor, so as to make the virtual machine monitor respond to the second interrupt instruction and read the communication feedback data from the preset DDR.

11. A method for processing inter-core communication, applied to an operating system, wherein the operating system runs based on a physical server resource allocated by a virtual machine monitor, and the method comprises:
sending inter-core communication data to the virtual machine monitor, so as to make the virtual machine monitor write a communication data content in the inter-core communication data into a preset memory, trigger a target CPU core to read the communication data content from the preset memory, and acquire communication feedback data, wherein the communication feedback data is feedback data corresponding to the communication data content and sent by the target CPU core; and
acquiring the communication feedback data acquired by the virtual machine monitor.

12. The method according to claim 11, wherein the sending inter-core communication data to the virtual machine monitor comprises:
writing the inter-core communication data into a preset RAM, releasing a CPU, and interrupting a program currently being executed, wherein the preset RAM is a RAM that is not readable or writable by the operating system.

13. The method according to claim 12, wherein after the inter-core communication data is sent to the virtual machine monitor by the operating system, the virtual machine monitor further acquires and stores context information of an execution program of the operating system; and
before the acquiring the communication feedback data obtained by the virtual machine monitor, the method further comprises:
reading the context information of the execution program stored in the virtual machine monitor, and recovering the execution program based on the context information of the execution program.

14. The method according to claim 11, wherein after acquiring the communication feedback data, the virtual machine monitor writes the communication feedback data into a preset RAM, and the preset RAM is a RAM that is not readable or writable by the operating system; and
the acquiring the communication feedback data acquired by the virtual machine monitor comprises:
reading the communication feedback data from the preset RAM.

15. A computer system, comprising:
an operating system, a virtual machine monitor, and a physical server,
wherein the virtual machine monitor is configured to run between the operating system and the physical server, and allocate a hardware resource of the physical server to the operating system, and the operating system is configured to run based on a physical server resource allocated by the virtual machine monitor;
the operating system is further configured to send inter-core communication data to the virtual machine monitor, and acquire communication feedback data acquired by the virtual machine monitor;
the virtual machine monitor is further configured to write a communication data content in the inter-core communication data sent by the operating system into a preset memory, trigger a target CPU core in the physical server to read the communication data content from the preset memory, acquire the communication feedback data, and feed back the communication feedback data to the operating system, wherein the communication feedback data is feedback data corresponding to the communication data content and sent by the target CPU core; and
the target CPU core in the physical server is configured to read the communication data content from the preset memory in response to a triggering operation of the virtual machine monitor, generate the communication feedback data corresponding to the communication data content, write the communication feedback data into the preset memory, and trigger the virtual machine monitor to acquire the communication feedback data.

16. The computer system according to claim 15, wherein the operating system comprises at least one guest operating system, and the virtual machine monitor provides a service interface for each guest operating system, and allocates different physical server hardware resources to each guest operating system; and
the physical server comprises a plurality of CPU cores.

17. The computer system according to claim 15, wherein the virtual machine monitor is built by a microkernel-based real-time operating system.

18-20. (canceled)
